(19) United States
(12) Patent Application Publication
(10) Pub. No.: US 2003/0088629 A1
(43) Pub. Date: May 8, 2003

(54) Email management system and method

(76) Inventors: Martin Berkowitz, West Hollywood, CA (US); Barbara Voss, Woodland Hills, CA (US)

Correspondence Address: ROBERT J. SCHAAP, Suite 188, 21241 Ventura Boulevard, Woodland Hills, CA, 91364, US

(21) Appl. No.: 10/005,788

(22) Filed: Nov. 8, 2001

(51) Int. Cl. G06F 15/16

(52) U.S. Cl. 709/206

(57) ABSTRACT

A method for intercepting and forwarding email messages in transit from one email address to another email address as specified by a user, who owns accounts at both the old and new email addresses. The method includes specifying the old and the new email addresses; logging the old and new email addresses into a computer database; intercepting email addressed to specific unique identifier TCP/IP address; locating unique identifier in the computer database for the old email address and unique identifier for the new email address; and rerouting the email from the old email address to the new email address.

### BACKGROUND OF THE INVENTION

1. Field of the Invention

This invention relates to Internet systems and processes. In particular, this invention relates to the handling of email messages on the Internet.

2. Brief Description of Related Art

Electronic mail is a tool that allows people to send and receive messages over any Internet or Intranet networked group of computers. When the end user, or person using the email software, sends an email, the user composes the message and selects an address of a person to whom the end user wants to send a message. The end user writes the message in his or her native language, such as English, and the address appears as the person's email name with the domain name system (“DNS”) address where the email address resides.

For example, if you want to send an email to Santa Claus, his address wold be SantaClaus@Northpole.com, where SantaClaus is the name of the mailbox of the person you want to send the email to, and Northpole.com is the domain name of his Internet address. An end user typically pays a fee to have his mailbox stored and maintained at an Internet company, called an Internet Service Provider (“ISP”). In this example, Northpole.com is the domain owned and used by Santa's ISP.

Since computers, however, cannot understand English, the name server computers translate the English address into numbers that the network computers can understand. The network computer needs to read an Internet protocol (“IP”) address, such as 123.48.32.121. Name servers work with the domain name server (“DNS”) to be sure that email goes to the correct person.

When the end user selects the send button in his email software, the email client software connects to the Simple Mail Transfer Protocol (“SMTP”) server that is specified in the client software program and tells the SMTP server the email address of the sender and the email address of the recipient. The SMTP server communicates with a DNS to obtain the IP address for the domain name of the recipient. The message to the domain name of the recipient then gets translated into packets of data. The packets of data list the destination address, expressed as numbers, for example as indicated above. When the packets enter the Internet, they are intercepted by routers, which read the destination address, attempt to select the most direct route for delivering the information, and forward the data.

The router forwards the email to an email gateway. The email gateway uses the transmission control protocol (“TCP”), which breaks down and reassembles packets, to reconstruct the IP packets into a full message. The gateway translates the message into the protocol the target network uses and sends it to the email address, i.e., to a specific message email box of the recipient.

Usually, email is sent by the end user, translated by the computer, travels through the router, gateway, to the email recipient and is translated from a computer to human language.

Just like in the land based world, however, people who use the Internet change addresses. Many times, a user's Internet email address corresponds to his or her Internet service provider's domain name. When a user changes Internet Service Providers, email that is addressed to him or her at the old Internet service provider will not arrive at the user's new Internet service provider. Email that is addressed to the user's old email address is sent and likely received by the old Internet service provider's email server. Because the user does not log on to the post office protocol (“POP3”) of the old Internet service provider, they will not receive the email messages that were addressed to the old email address.

Others have addressed the problem of handling the change of a user's mailbox internal to a specific domain server, but not the significant problem that occurs when a user changes his mailbox from one domain name server to another. For example, see U.S. Pat. No. 5,822,526.

As a result, users may attempt to contact those people who are in their address lists to notify them of their new email address. Inevitably, however, printed material such as advertisements, letterhead or business cards, will have the user's old email address on them and people will send email to the old address. After the user has discontinued service with the old Internet service prover, the old Internet service provider can compound the problem by bouncing email messages that are sent to the user's old email address back to the sender, stating to the effect, “user not known.” This is similar to the situation in the land based world where an envelope is returned by the postal delivery service, undeliverable as addressed or forwarding order expired.

What is needed is a system and method of forwarding email messages from a user's old email address to the user's new email address.

### BRIEF SUMMARY OF THE INVENTION

The purpose of this invention is to provide a service whereby the end user can have email that is sent to his or her old email address, automatically forwarded to his or her new email address. So that, for example, if Santa wanted all his email to a new email address for this year's Christmas to a faster ISP, he could use this system and method to specify his old email address as SantaClaus@Northpole.com and forward his email to his email address at SantaClaus@Reindeer.com.

A method is provided of intercepting, rerouting and forwarding email messages in transit from one email address to another email address, which comprises the steps of specifying the old and the email addresses; logging the old and the new email addresses into a computer database; intercepting email addressed to a specific unique identifier TCP/IP address; locating the unique identifier in said computer database for the old email address and unique identifier for the new email address; and rerouting mail from the old email address to the new email address.

The interception of emails that are addressed to the old email address comprises the steps of identifying the Internet protocol address of the mail server that manages the old email address; capturing all email headers that are addressed to the specific unique identifier TCP/IP address that arrive at the mail server of the user's former Internet service provider; storing the captured email messages into buffer memory; and relaying the stored email messages to the user's new email address.

This invention primarily relates to the email management system and method therefor as described herein, but also possesses many other advantages and has other purposes which will be made more fully apparent from a consideration of the forms in which it may be embodied. One of the forms of this method and, for that matter, the associated program and algorithm, is more fully described in the following description, and more fully illustrated in the accompanying drawings. However, it is to be understood that these drawings and the following detailed description are set forth for purposes of illustrating and describing the general principles of the invention and are not to be taken in a limiting sense.

### BRIEF DESCRIPTION OF THE DRAWINGS

Having thus described the invention in general terms, reference will now be made to the accompanying drawings in which:

FIG. 1 shows the business transaction steps of the email management system;

FIG. 2 shows the network architecture steps of the email management system; and

FIG. 3 shows the network monitoring and forwarding steps of the email management system.

### DETAILED DESCRIPTION OF A PREFERRED EMBODIMENT

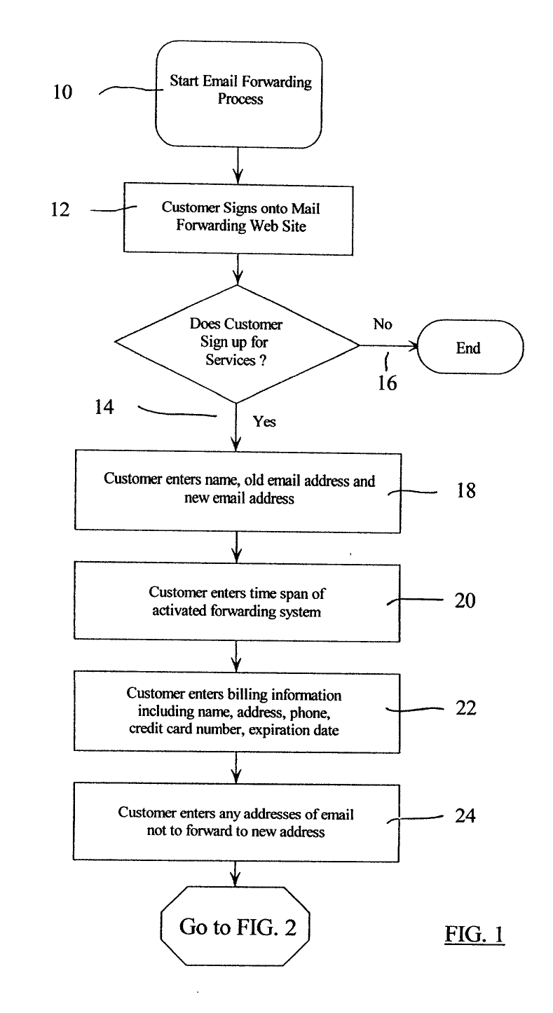

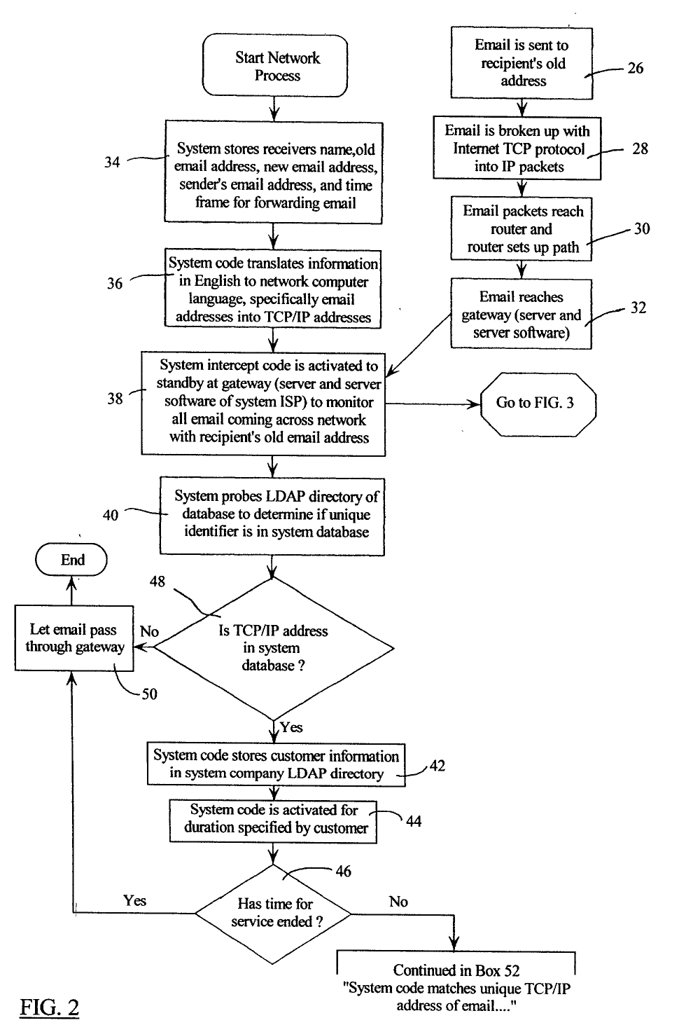

Referring now in more detail and by reference characters to the drawings, referring to the Flow Chart in FIG. 1, the end user, or customer, connects to the Internet 10 and logs onto the email exchange web site 12. At the email exchange web site, after reviewing the system features and benefits, the customer can decide to sign up for service 14 or not sign up 16. If the customer elects to sign up for service, he must enter his name, the old email address and new email address 18. The customer must also enter the time duration of the forwarding service 20. The customer must also enter his billing information 22. The customer is provided with the option of listing email addresses from which he does not want to receive forwarded email 24. After the preliminary business side of the process is completed, the network architecture side of the process is launched.

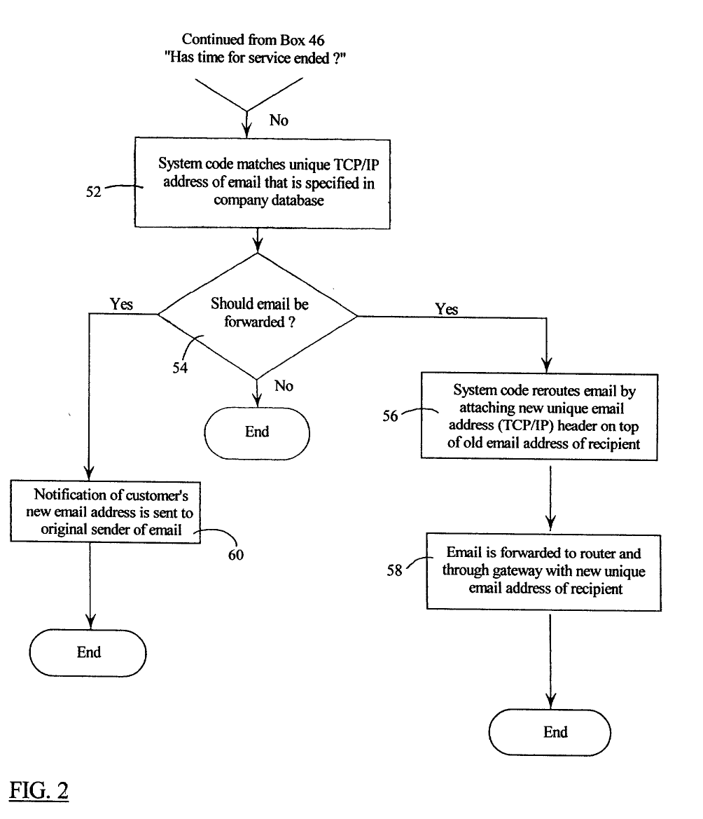

FIG. 2 illustrates a flow chart of the network architecture side of the email management process.

When an email message is sent to the end user 26, the email is translated by the TCP protocol into the IP packets of information 28. The resulting packets cross through a router that specifies the path for the email 30 to take through the network to its specified address. The email reaches the gateway, or server software 32. After the user has entered the necessary information described in FIG. 1, the email management system stores the information 34 and translates it from English to network computer languages, specifically email addresses into TCP/IP addresses 36.

After the email management system has received instructions to monitor the gateways, that email passes through, and the email system is activated to watch for email sent to a specific end user's name and address 38.

When the email management system identifies the name and email address of a customer, it probes the Lightweight Directory Access Protocol (“LDAP”) directory to locate the new name and email address for forwarding the email 40. The system code stores information in the company LDAP directory that lists the information the customer entere+10X44. The email management system then evaluates the time frame for forwarding to determine if it is still active 46. If the time frame is still active, the system determines if the TCP/IP address is in the system database 48. If it is not, the email passes through the gateway 50. If it is, the email management system matches the unique TCP/IP address of email that is specified in the company database to the email message 52 and makes a determination whether the message should be forwarded 54. The system reroutes the message by attaching the new email address (TCP/IP) header to the email message 56 and forwards the message back to the router and sends it to the gateway 58. The router defines the new pathway based upon the new email address and sends the email to the new email address. The email management system also notifies the sender of the receiver's new email address if the receiver indicated to do so.

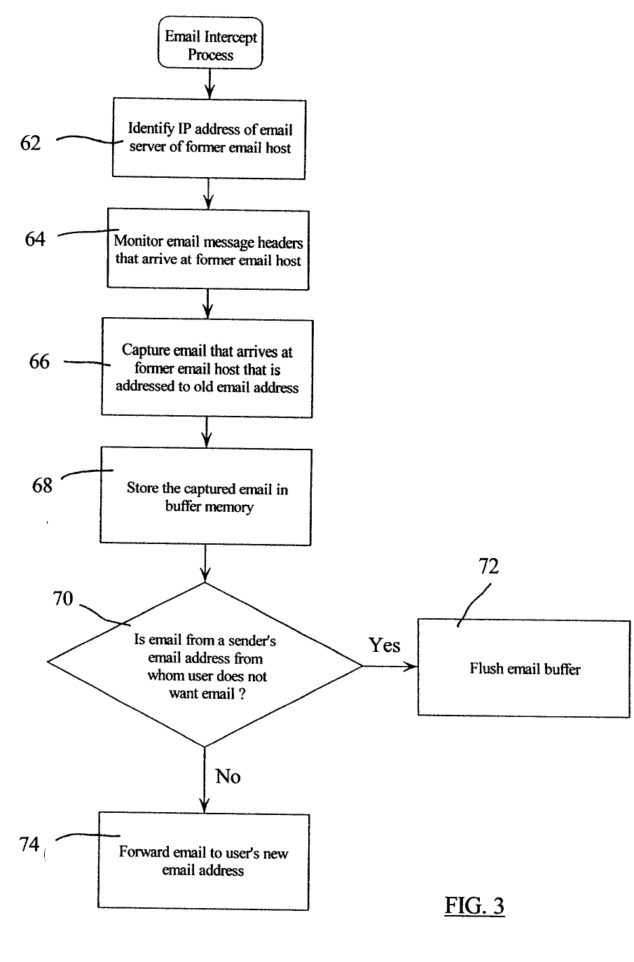

The flow chart in FIG. 3 illustrates the Identification and evaluation steps of the email management process. The process first identifies the IP address of the mail server of the form email host 62. All email message headers are then evaluated that arrive at the form email host 64. Email that arrives at the former host that is addressed to old email address is captured 66 and stored in buffer memory 68. The email header is then evaluated to determine if it is from a sender from whom the user does not want to receive email 70. If it is from an undesirable sender, the message is flushed from the buffer memory 72, and if it is not, it is forwarded to the new email address 74. The email management system allows new email to pass through the gateway to the new email address of the end user.

The method may also include IP fragmentation or TCP segment reordering to reorder any packets that are received during the minoring of the process (Step 38).

Thus, there has been illustrated and described a unique and novel email management system and method which effectively forwards email messages from a user's old email address to the user's new email address, and which thereby fulfills all of the objects and advantages which have been sought therefor. It should be understood that many changes, modifications, variations and other uses and applications will become apparent to those skilled in the art after considering this specification and the accompanying drawings. Therefore, any and all such changes, modifications, variations and other uses and applications which do not depart from the spirit and scope of the invention are deemed to be covered by the invention.

Having thus described the invention, what we desire to claim and secure by letters patent is:

1. A series of program steps to intercept and reroute emails which were addressed to an old address and to thereby transmit such emails to a new address, said steps comprising:
a) storing information about old an email address;
b) storing information about a new email address which is to receive email intended for the old email address;
c) separately storing in a buffer memory and analyzing email addressed to the old email address; and
d) rerouting the email to the new email address.

2. The series of program steps of claim 1 further characterized in that the series of steps further comprises establishing a time frame for the rerouting to take place and determining if the rerouting is to occur in that time frame.

3. The series of program steps of claim 1 further characterized in that the series of steps further comprises breaking up the email into individual packets and the packets thereof are separately transmitted and regrouped.

4. The series of program steps of claim 3 further characterized in that the series of steps further comprises determining if the packets are in a proper order and reordering same if necessary and thereafter forwarding the email to the new email address.

5. The series of program steps of claim 1 further characterized in that the method comprises the providing of a code in the old and new email addresses to cause an email addressed to the old address to be automatically rerouted to the new address.

6. A method of intercepting, rerouting and forwarding email messages in transit from one from one email address to another email address comprising the steps of:
a) specifying the old and the new email addresses;
b) logging said old and new email addresses into a computer database;
c) intercepting email addressed to specific unique identifier TCP/IP address;
d) locating a unique identifier in said computer database for said old email address and unique identifier for said new email address; and
e) rerouting email from said old email address to said new email address.

7. The method as claimed in claim 6 wherein a message is sent to the sender notifying him or her of the change of email address of the recipient.

8. The method as claimed in claim 6 wherein a predetermined time frame is designated in which the forwarding procedure is to occur; said time period having a specified beginning time and ending time.

9. The method as claimed in claim 6 wherein said interception comprises the steps of:
a) identifying the Internet protocol address of the mail server that manages said old email address;
b) capturing all email headers that arrive at said mail server as identified in Step (a) that are addressed to said specific unique identifier TCP/IP address;
c) storing said email identified in Step (b) in a buffer;
d) relaying said email stored in Step (c) to said new email address.

10. The method claimed in claim 6 wherein said method includes the is step of evaluating said email message to determine if the packets are in the proper order and if the packets in said email message are out of order, reordering said packets into the proper order prior to sending the message to said new email address.

11. A series of program steps to intercept and reroute emails addressed to an old address to transmit such email to a new address, said steps comprising:
a) storing information about an old email address;
b) storing information about a new email address which is to receive email intended for the old email address;
c) correcting the old and new email addresses into TCP/IP addresses;
d) monitoring all old email addresses at a server for the recipient of the old and new email addresses;
e) separately storing in a buffer memory and analyzing email addressed to the old email address;
f) establishing a database of the TCP/IP addresses and determining if a found TCP/IP for an email is in the database;
g) determining if TCP/IP code for old email addresses corresponds to a TCP/IP code of the new email addresses;
h) determining if the email should be forwarded; and
i) rerouting the email to the new email address if it is to be forwarded.

12. The series of program steps of claim 11 further characterized in that the series of steps further comprises establishing a time frame for the rerouting to take place and determining if the rerouting is to occur in that time frame.

13. The series of program steps of claim 11 further characterized in that the series of steps further comprises breaking up the email into individual packets and the packets thereof are separately transmitted and regrouped.

14. The series of program steps of claim 13 further characterized in that the series of steps further comprises determining if the packets are in a proper order and reordering same if necessary and thereafter forwarding the email to the new email address.
